(19) United States
(12) Patent Application Publication
(10) Pub. No.: US 2009/0171838 A1
(43) Pub. Date: Jul. 2, 2009

(54) SYSTEMS AND METHODS WHEREIN A CREDIT PRODUCT IS OFFERED IN ACCORDANCE WITH USAGE OF A PRE-PAID CARD ACCOUNT

(76) Inventors: Alexander A. Liu, New York, NY (US); Ron Hynes, Ridgefield, CT (US)

Correspondence Address: BUCKLEY, MASCHOFF & TALWALKAR LLC, 50 LOCUST AVENUE, NEW CANAAN, CT, 06840, US

(21) Appl. No.: 11/965,156

(22) Filed: Dec. 27, 2007

(51) Int. Cl. G06Q 40/00

(52) U.S. Cl. 705/40; 705/39; 705/43

(57) ABSTRACT

According to some embodiments, a consumer is associated with a pre-paid card account. Purchase transactions for the consumer may be facilitated via the pre-paid card account, including a transfer of funds out of the pre-paid card account. Funds may also be transferred for the consumer to re-load the pre-paid card account. The consumer's usage of the pre-paid card account may be tracked, and at least one credit product to be offered to the consumer may be determined based on said tracking.

### FIELD

The present invention relates to credit products and pre-paid card accounts. In particular, the present invention relates to systems and methods wherein a credit product may be offered to a consumer in accordance with usage of a pre-paid card account.

### BACKGROUND

Many consumers may find it difficult to receive credit products, such as traditional credit cards. For example, consumers without a bank account, consumers with few assets, and/or consumers without an established credit history may be unable to open a traditional credit card account. One reason for this difficultly is that credit products are often offered to consumers based on their credit history or credit “score.” As a result, consumers who do not have a credit history (or who have a low credit score) are often not served, or are under-served, with respect to credit products.

In some cases, these consumers are provided with access to other types financial services, such as pre-paid transaction cards. The use of such services, however, is not typically reflected in the consumer's credit score. Therefore, using a pre-paid transaction card will not provide an opportunity for the consumer to eventually migrate to credit products.

It would be desirable to provide systems and methods that would let responsible consumers eventually receive credit products. It would be particularly advantageous if such a system operated in a timely and reliable fashion.

### SUMMARY

To alleviate problems inherent in the prior art, the present invention introduces systems and methods wherein a credit product may be offered to a consumer in accordance with usage of a pre-paid card account.

According to one embodiment, a consumer is associated with a pre-paid card account. Purchase transactions are facilitated for the consumer via the pre-paid card account, wherein funds are transferred out of the pre-paid card account. In addition, funds may be transferred for the consumer to re-load the pre-paid card account. The consumer's usage of the pre-paid card account is tracked, and at least one credit product is determined to be offered to the consumer based on said tracking.

Another embodiment of the present invention comprises: means for associating a consumer with a pre-paid card account; means for receiving a transaction request, associated with the pre-paid card account, from a remote merchant device; means for transmitting a transaction approval to the remote merchant device; means for transferring funds out of the pre-paid card account based on the transaction request; means for receiving a re-load indication from the consumer; means for transferring funds for the consumer to re-load the pre-paid card account in response to the re-load request; means for storing transaction information associated with the consumer's usage of the pre-paid card account; means for receiving from a third-party supplemental information associated with the consumer; based on the stored transaction information and the supplemental information; means for generating a score associated with the consumer; means for offering a first credit product to the consumer if the score is in a pre-determined relationship with a first threshold value; and means for offering a second credit product to the consumer if the score is in a pre-determined relationship with a second threshold value.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a block diagram representation of a system that may be provided according to some embodiments.

FIG. 2 is a block diagram of a financial institution device according to some embodiments.

FIG. 3 is a flow chart that illustrates a method that may be performed according to some embodiments.

FIG. 4 is a block diagram of an apparatus according to some embodiments.

FIG. 5 is a portion of a tabular representation of a consumer database according to some embodiments.

FIG. 6 is a portion of a tabular representation of a pre-paid card account database according to some embodiments.

FIG. 7 is a portion of a tabular representation of a credit product database according to some embodiments.

FIG. 8 is a flow chart that illustrates a method that may be performed according to some embodiments.

### DETAILED DESCRIPTION

Some embodiments of the present invention are associated with a “consumer” who uses a pre-paid card account and/or receives offers for consumer credit products. As used herein, the term “consumer” might refer to, for example, a person (or entity) who executes transactions with merchants. Moreover, the term “pre-paid card account” might refer to, for example, any financial account used by the consumer to perform such transactions without utilizing traditional credit products (or with only limited utilization of such products). In addition, the phrase “credit product” might refer to, for example, a traditional credit card account, a private label credit card account, a card account having overdraft protection, and/or a partially secured credit card account.

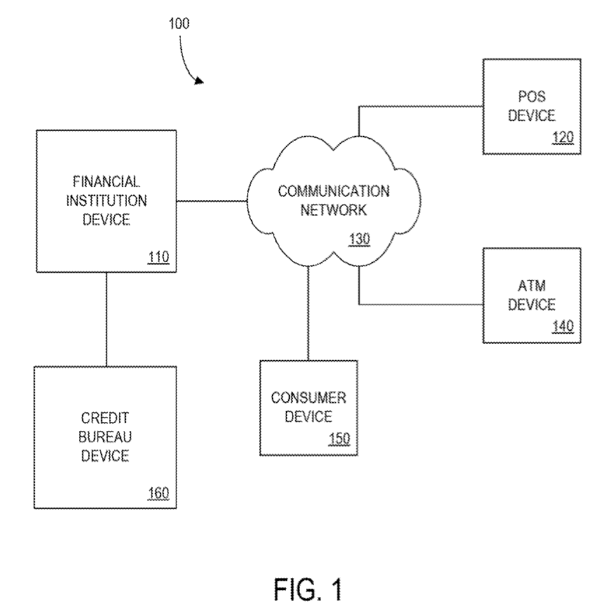

Turning now in detail to the drawings, FIG. 1 is a block diagram representation of a system 100 that may be provided according to some embodiments. The system 100 includes a financial institution device 110 in communication with other devices via a communication network 130. The financial institution device 110 may be associated with, for example, a company or service that offers pre-paid card accounts and/or traditional credit card accounts to consumers.

As used herein, devices (including the financial institution device 110) may communicate, for example, via a communication network 130 such as a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a cable television network, or an Internet Protocol (IP) network such as the Internet, an intranet or an extranet. Moreover, as used herein, communications include those enabled by wired or wireless technology. Although a single financial institution device 110 and communication network 130 are shown in FIG. 1, any number of such devices and networks may be included in the system 100. Similarly, any number of the other devices described herein may be included in the system 100 according to embodiments of the present invention.

The financial institution device 110 might communicate with, for example, one or more Point Of Sale (POS) devices 120, such as remote POS terminals located at various merchant and/or retail establishments. The POS devices 120 might include magnetic stripe card readers, proximity coupling devices and/or other peripheral devices which allow the terminals to receive account numbers from pre-paid payment cards presented at the terminal by cardholders (consumers) to pay for transactions. The pre-paid cards may be physically similar to conventional credit or debit cards, for example. After reading or otherwise receiving a pre-paid card account number, a POS device 120 submits a request for authorization of the transaction. The request for authorization typically includes the pre-paid card account number, the amount of the transaction, the identity of the merchant which operates the POS device 120, and other information. In some embodiments, the POS device 120 operates in a conventional manner. The financial institution device 110 may then determine whether the requested transaction is to be authorized. According to some embodiments, the financial institution device 110 is operated by a payment card association, such as MasterCard International Incorporated, the assignee hereof.

The financial institution device 110 might also communicate with, for example, one or more Automated Teller Machine (ATM) devices 140. For example, a consumer might present a pre-paid card at an ATM device 140 and enter his or her Personal Identification Number (PIN). After the information is verified, the consumer might use the ATM device 140 to receive cash from his or her pre-paid card account and/or to re-load funds into his or her pre-paid card account. In some embodiments, the ATM device 140 operates in a conventional manner.

In addition or alternatively, the system 100 may include a call center (not illustrated in FIG. 1). The call center may be staffed by human operators who take telephone calls from consumers and/or merchants (in addition or alternatively the call center may include an automatic voice response unit). In such an embodiment, the call center human operators may receive information from the consumers and/or merchants to authorize cash disbursements and/or purchases.

The financial institution device 110 might also communicate with, for example, one or more consumer devices 150. For example, the financial institution device 110 might communicate with a remote Personal Computer (PC) or laptop computer associated with a consumer via the Internet. Although some embodiments are described with respect to information exchanged via a Web site, according to other embodiments information is instead exchanged, for example, via: a telephone, an Interactive Voice Response Unit (IVRU), electronic mail, a cable network interface, and/or a wireless communication system. The consumer device 150 may be any device capable of performing various functions described herein. The consumer device 150 might be, for example, a Personal Digital Assistant (PDA) or a wired or wireless telephone. A consumer may use the consumer device 150, for example, to make on-line purchases or bill payments, to apply for pre-paid card accounts, and/or to receive and/or accept offers for credit products.

According to some embodiments, the financial institution device 110 also communicates with a credit bureau device 160. For example, the financial institution device 110 may receive supplemental information about a consumer (e.g., an EQUIFAX® credit score) from the credit bureau device 160. Although a separate financial institution device 110 and credit bureau device 160 are shown in FIG. 1, some or all of these devices may be incorporated in a single device.

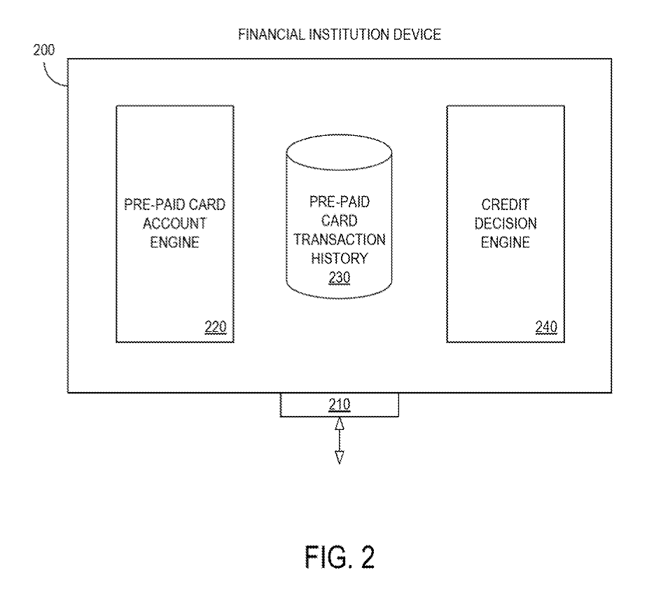

FIG. 2 is a block diagram of a financial institution device 200, such as the device 110 described with respect to FIG. 1, according to some embodiments. In this case, the financial institution device 200 includes a communication port 210 to exchange data over a network to facilitate communication with, for example, other devices (such as POS devices 120, ATM devices 140, and consumer devices 150). Note that numerous ports 210 may be provided (to allow for simultaneous communication with a number of other devices) and may be preferably configured with hardware suitable to physically interface with desired external devices and/or network connections. For example, the communication port 210 may comprise an Ethernet connection to a local area network through which the financial institution device 200 may receive and transmit information over the Internet and/or over private or proprietary networks.

In addition, the financial institution device 200 includes a pre-paid card account engine 220 and a credit decision engine 240 that may be constituted by one or more conventional processors. The engines 220, 240 operate to execute processor-executable process steps so as to control the financial institution device 200 to provide desired functionality. The financial institution device 200 further includes a storage device 230 to store pre-paid card transaction history information. Note that the engines 220, 240 and storage device 230 may be co-located with, or remote from, the financial institution device 200.

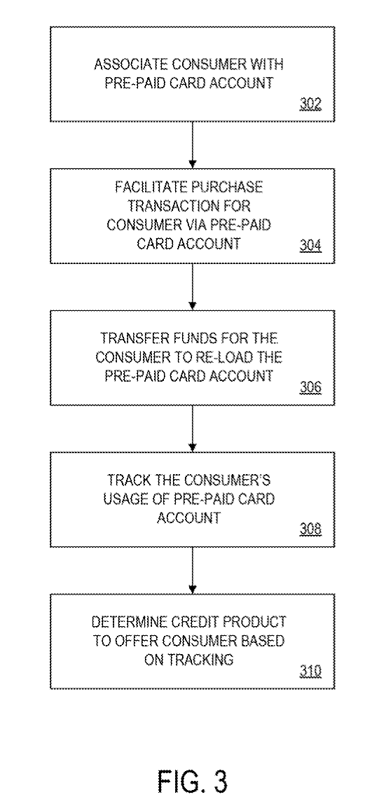

The financial institution device 200 may operate in accordance with any of the embodiments described herein. By way of example only, FIG. 3 is a flow chart that illustrates a method that may be performed according to some embodiments. The flow charts in FIG. 3 and the other figures described herein do not imply a fixed order to the steps, and embodiments of the present invention can be practiced in any order that is practicable. Moreover, the methods may be performed by any of the devices described herein. The method shown in FIG. 3 may be performed, for example, by the financial institution device 110 of FIG. 1 and/or the financial institution device 200 of FIG. 2. Note that the elements of FIG. 3 and the other FIGS. described herein may be performed by different parties. For example, each element might be performed by a different party (e.g., by an issuer, an account processor, or any other agent or party). Moreover, any single element might be performed by multiple parties.

At 302, a consumer may be associated with a pre-paid card account. For example, a consumer may apply for a pre-paid card account and provide an initial payment to be applied to the account. According to some embodiments, the pre-paid card account is co-branded with a retail partner. The pre-paid card account engine 220 may approve the consumer's application and arrange for a pre-paid card to be physically issued to the consumer.

At 304, purchase transactions are facilitated for the consumer via the pre-paid card account, including a transfer of funds out of the pre-paid card account. For example, the pre-paid card account engine 220 might receive an indication from a POS device that a particular account is being used to purchases goods or services. The pre-paid card account engine 220 may approve the transaction and reduce the amount of pre-paid funds available to that account by an appropriate amount. According to some embodiments, the pre-paid card account engine 220 might similarly facilitate the distribution of cash to the consumer (e.g., via an ATM device 140) and/or online purchases or bill paying.

Funds may also be transferred at 306 for the consumer to re-load the pre-paid card account. For example, the consumer might present his or her pre-paid card and provide cash to a merchant at a POS device 120. In this case, the pre-paid card account engine 220 might increase the amount of pre-paid funds available to that account by an appropriate amount. According to some embodiments, funds may be re-loaded through a direct payroll deposit and/or an online transfer. Note that in some embodiments, the steps performed at 304 and/or 306 may be performed by a financial institution acting as a bank account or a debit card processor substitute for the consumer.

At 308, the consumer's usage of the pre-paid card account is tracked. For example, the pre-paid card account engine 220 might update pre-paid card transaction history information in the storage device 230 each time a transaction is executed. The usage information might include, for example, an amount of funds being spent or re-loaded, whether or not a request was denied, etc.

At 310, at least one credit product to be offered to the consumer is determined based on the information tracked at 308. For example, the credit decision engine 240 may evaluate the usage information to determine which, if any, credit products should be offered to a particular consumer. The credit product offered to the consumer might be associated with, for example, a traditional credit card account, a private label credit card account, a card account with overdraft protection (that is, the credit product might be linked to the card account), and/or a partially secured credit card account. According to some embodiments, the credit product determined at 310 is further based on credit bureau data (e.g., a credit score received from a credit bureau device 160).

The determined credit product may then be offered to the consumer. For example, a traditional credit account may be offered to the consumer based on his or her responsible use of a pre-paid card account. According to some embodiment, a rule or threshold value may be applied to the pre-paid account history information in order to select an appropriate credit product for the consumer. Note that the terms and conditions associated with the credit product might also be based on his or her use of the pre-paid card account. The credit product may then be provided to the consumer (assuming the consumer accepts the offer).

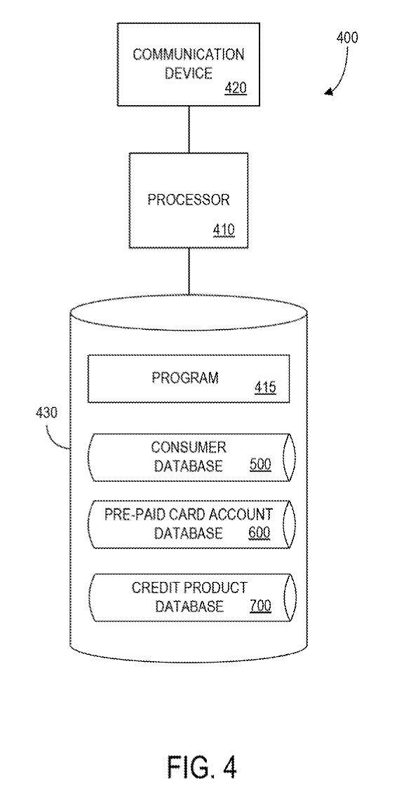

FIG. 4 is a block diagram of an apparatus 400 that may be descriptive of the devices shown in FIGS. 1 and/or 2 according to an embodiment of the present invention. The apparatus 400 comprises a processor 410, such as one or more INTEL® Pentium® processors, coupled to a communication device 420 configured to communicate via a communication network (not shown in FIG. 4). The communication device 420 may be used to communicate, for example, with POS devices 120, ATM devices 140, consumer devices 150, and/or credit bureau devices 160.

The processor 410 may also be in communication with a local input device (not shown in FIG. 4). The local input device may comprise, for example, a keyboard, a mouse or other pointing device, a switch, an infrared port, a docking station, and/or a touch screen. Such a local input device may be used, for example, to provide rules and threshold values associated with credit product offers. The processor 410 may also be in communication with a local output device (not shown in FIG. 4). The local output device may comprise, for example, a display (e.g., a computer monitor), a speaker, and/or a printer. The local output device may be used, for example, to generate reports and/or export information to be used to generate credit product offers for consumers.

The processor 410 is also in communication with a storage device 430. The storage device 430 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 430 stores a program 415 for controlling the processor 410. The program 415 may be stored in a compressed, uncompiled and/or encrypted format. The program 415 may furthermore include other program elements, such as an operating system, a database management system, and/or device drivers used by the processor 410 to interface with peripheral devices.

The processor 410 performs instructions of the program 415, and thereby operates in accordance with the present invention. For example, the processor 410 may associate a consumer with a pre-paid card account and facilitate purchase transactions for the consumer via the pre-paid card account, including transfers of funds out of the pre-paid card account. The processor 410 may further arrange to transfer funds for the consumer to re-load the pre-paid card account and track the consumer's usage of the pre-paid card account. According to some embodiments, the processor 410 also determine at least one credit product to be offered to the consumer based on said tracking.

As used herein, information may be “received” by or “transmitted” to, for example: (i) the apparatus 400 from remote device; or (ii) a software application or module within the apparatus 400 from another software application, module, or any other source.

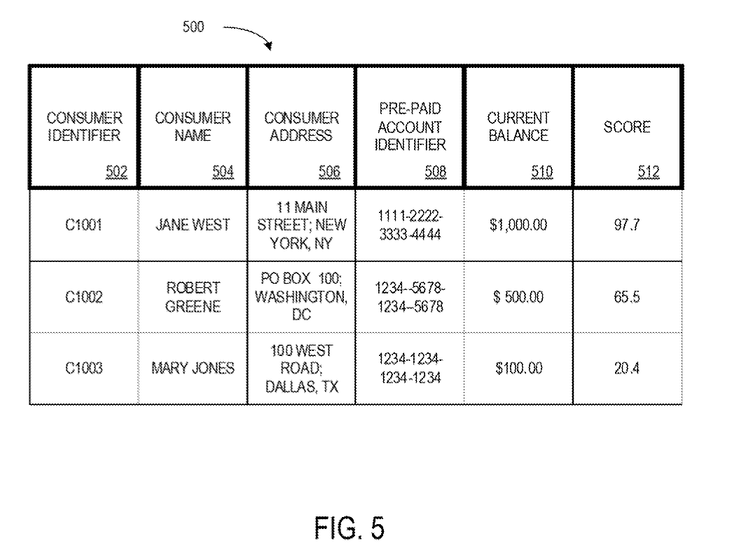

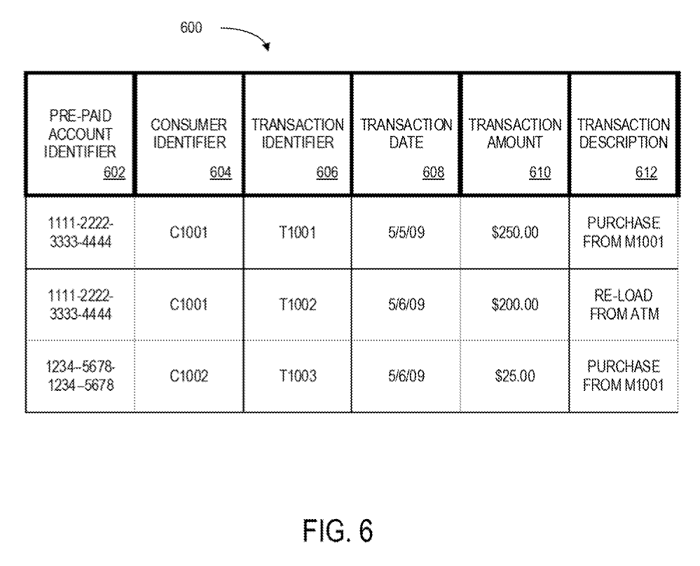

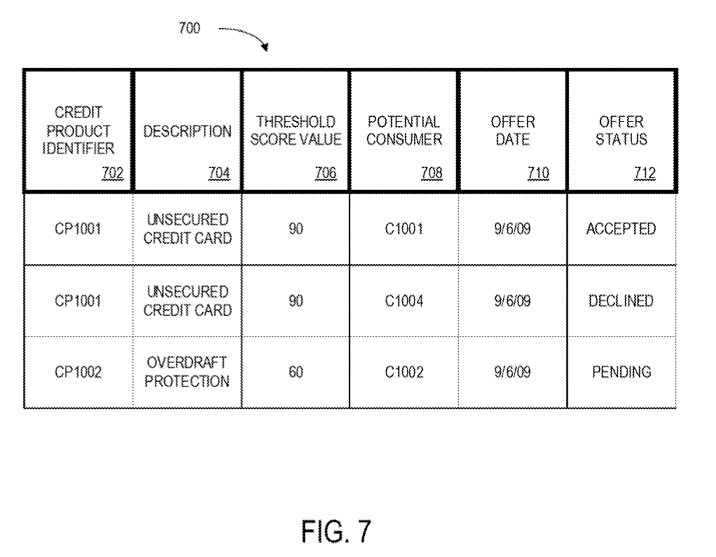

As shown in FIG. 4, the storage device 430 also stores a consumer database 500 (described with respect to FIG. 5), a pre-paid card account database 600 (described with respect to FIG. 6), and a credit product database 700 (described with respect to FIG. 7). Examples of databases that may be used in connection with the apparatus 400 will now be described in detail with respect to FIGS. 5 through 7.

Note that the illustrations and accompanying descriptions of the databases 500, 600, 700 presented herein are exemplary, and any number of other database arrangements could be employed besides those suggested by the figures. For example, as will be understood by those skilled in the art, the schematic illustrations shown herein and the following descriptions of the exemplary entries are merely examples of arrangements for stored representations of information. Any number of other arrangements may be employed besides that suggested by the tables shown. Similarly, the illustrated entries of the databases represent exemplary information only.

In a practical embodiment, the number of entries in the various databases may be in the thousands, or even in the millions. Moreover, for convenience of presentation, some databases are shown as having only six fields. However, in practice additional fields may be present, such as other fields for additional consumer contact information, social security number, etc. Moreover, the various databases may generally be integrated with other databases used for other purposes in addition to those described herein. Also, note that the information stored in the database 500, 600, 700 may be stored by (or at) and/or accessed by any number of different parties or locations (e.g., by an issuer, an account processor, and/or any other agent or party). For example a credit product database 700 might be partially stored at an issuing back's system and partially stored on that bank's outsourced credit processor's system (and, when combined, form the complete credit product database 700).

FIG. 5 is a portion of a tabular representation of a consumer database 500 that may be stored at the apparatus 400 according to an embodiment of the present invention. The table includes entries identifying consumers associated with pre-paid card accounts. The table also defines fields 502, 504, 506, 508, 510, 512 for each of the entries. The fields specify: a consumer identifier 502; a consumer name 504; a consumer address 506; a pre-paid account identifier 508; a current balance 510; and a score 512. The information in the consumer database 500 may be created and updated, for example, based on information received from a consumer when or she applies for a pre-paid card account. The information in the consumer database 500 may also be based on, for example, information generated as the consumer uses his or her pre-paid card.

The consumer identifier 502 may be, for example, an alphanumeric code associated with a particular consumer. The consumer name 504 and consumer address 506 may further be associated with that consumer. The consumer information 502, 504, 506 may be generated by, for example, a financial institution or the consumer (e.g., when he or she provides information when applying for a pre-paid card account). The consumer address 506 might be associated with, for example, a postal mail address, an email address, or any other contact information (e.g., a telephone number). The consumer address 506 might be used, for example, to provide an offer for a credit product to qualified consumers.

The pre-paid account identifier 508 may comprise, for example, a unique account number or digital payment protocol information. The pre-paid account identifier 508 may be printed and/or encoded on a physical card or device and may be used, for example, to arrange for the consumer to provide or receive payment from his or her pre-paid account. The current balance 510 may reflect the funds that are presently available in the consumer's account.

The score 512 may be any metric that has been calculated for the consumer based on his or her usage of the pre-paid card account. For example, certain behaviors by the consumer might increase the score 512 while other behaviors might decrease the score 512. Note that the score 512 might comprise a general classification, a ranking (e.g., as compared to other consumers), a probability, and/or a set of values.

FIG. 6 is a portion of a tabular representation of a pre-paid card account database 600 that may be stored at the apparatus 400 according to an embodiment of the present invention. The table includes entries identifying transactions associated with a pre-paid card account. The table also defines fields 602, 604, 606, 608, 610, 612 for each of the entries. The fields specify: a pre-paid account identifier 602; a consumer identifier 604; a transaction identifier 606; a transaction date 608; a transaction amount 610; and a transaction description 612. The information in the pre-paid card account database 600 may be created and updated, for example, based on information received from merchant devices. The information in the pre-paid card account database 600 may also be based on, for example, information generated as a consumer uses (or attempts to use) his or her pre-paid account card.

The pre-paid account identifier 602 may be, for example, an alphanumeric code associated with a particular pre-paid card account (and may be based on, or associated with, the pre-paid account identifier 508 in the consumer database 500). Similarly, the consumer identifier 604 may be, for example, an alphanumeric code associated with a consumer (and may be based on, or associated with, the consumer identifier 502 in the consumer database 500).

The transaction identifier 606, transaction date 608, and transaction amount 610 may represent a particular transaction associated with the pre-paid card account. For example, the transaction information 606, 608, 610 might indicate that a consumer has made a purchase from a particular merchant or has re-load funds to the account from an ATM device as indicated by the transaction description 612. According to some embodiments, the transaction description 612 might indicate that a particular transaction was not approved (e.g., because the current balance 510 was less than then the transaction amount 610).

FIG. 7 is a portion of a tabular representation of a credit product database 700 that may be stored at the apparatus 400 according to an embodiment of the present invention. The table includes entries identifying credit products that have been (or might be) offered to consumers. The table also defines fields 702, 704, 706, 708, 710, 712 for each of the entries. The fields specify: a credit product identifier 702; a description 704; a threshold score value 706; a potential consumer 708; an offer date 710; and an offer status 712. The information in the credit product database 700 may be created and updated, for example, based on information received from credit card companies. The information in the credit product database 700 may also be based on, for example, information generated as consumer's accept or decline credit card offers.

The credit product identifier 702 may be, for example, an alphanumeric code associated with a particular credit product offer that might be provided to consumers, such as an unsecured credit card or overdraft protection as indicated by the description 704.

The threshold score value 706 may represent a condition that defines which consumers should receive an offer for the credit product. For example, the threshold score value 706 might be compared to the scores 512 in the consumer database 500 to select a group of consumers who should receive an offer for a particular unsecured credit card. Note that the threshold score value 706 might comprise a general classification (e.g., “high” or “low” risk), a ranking (e.g., as compared to other consumers), a probability, and/or a set of values.

The potential consumer 708 may represent a consumer who has received an offer for the credit product (and may be based on, or associated with, the consumer identifier 502 in the consumer database 500). The offer date 710 and offer status 712 might indicate when the consumer received the offer and whether the offer was “accepted” or “declined” by the consumer (or if the offer is still “pending”).

By way of example, the unsecured credit card offer associated with an identifier 702 of “CP1001” might only be given to consumers that have a score 512 of at least “90” in the consumer database (as indicated by the threshold score value 706). As a result, the credit card might be offered to “Jane West” (who is associated with a score 512 of “97.7”) but not to “Mary Jones” (who only has a score 512 of “20.4”).

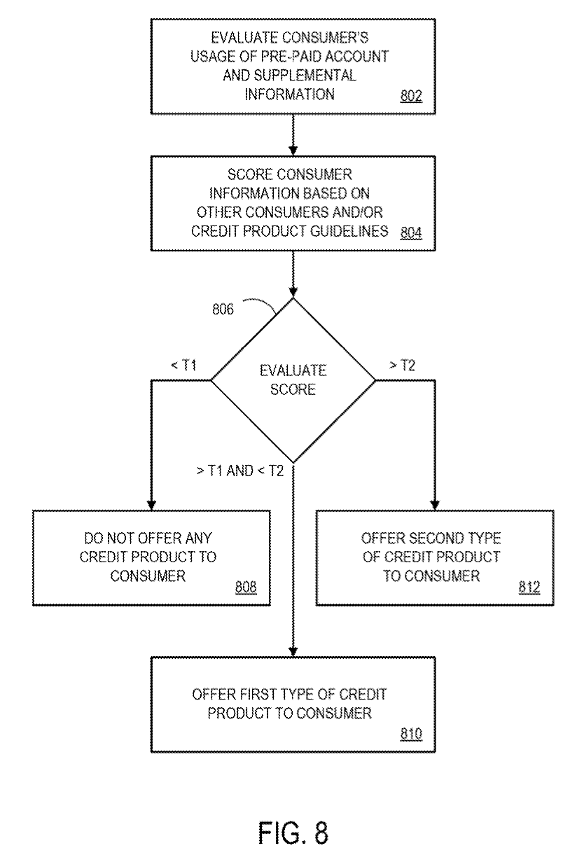

FIG. 8 is a flow chart that illustrates a method that may be performed according to some embodiments. The method might be performed, for example, after a consumer has been associated with a pre-paid card account for a pre-determined period of time. Note that a record will have been opened and updated in the consumer database 500 in connection with that account.

As he or she uses the account, various transaction requests may have been received from remote merchant devices, and various transaction approvals may have been transmitted to those devices. Moreover, funds will have been transferred out of the pre-paid card account based on the transaction request. Similarly, a number of re-load indications may have been received from the consumer, and funds will have been transferred to re-load the pre-paid card account in response to the re-load request.

As a result, transaction information associated with the consumer's usage of the pre-paid card account will be stored in the pre-paid card account database 600. At 802, the information in the pre-paid card account database 600 is evaluated. For example, the transaction amounts 610, frequencies (based on transaction dates 608), and descriptions 612 may be evaluated. In addition, supplemental information associated with the consumer is received from a third party and evaluated at 802. For example, whether or not the consumer typically pays a telephone bill (or rent) in a timely fashion may be evaluated along with his or her income/employment history, bankruptcy status, and/or average daily balance in a checking account.

At 804, the consumer information is scored. For example, the consumer information may be input to a set of rules or calculations to generate the score 512 in the consumer database 500. According to some embodiments, different scores may be generated in connection with different credit products (e.g., different credit products might have different guidelines or formulas that are used to generate the score). According to other embodiments, the score is at least partially based on the information about other consumers (e.g., indicating whether or not a particular consumer is in the top five percent with respect to a certain metric).

At 806, the score is evaluated. For example, a score might be compared to threshold values “T1” and “T2.” According to other embodiments, simpler or more complex scores and/or evaluations may be appropriate. For example, all consumers might be evaluated to determine whether they are “high” or “low” risk. As another example, consumer information might be evaluated based on a flow or process that branches out in different ways based on the consumer's habits (e.g., the types of merchants he or she has used in connection with the pre-paid card account).

Based on the evaluation at 806, a financial institution might determine that no credit product should be offered to the consumer at 808. For example, no credit product might offered if the consumer's score was below a minimal threshold value T1. In contrast, a first type of credit product might be offered at 810 to consumers who met the minimal threshold value T1 but failed to meet another threshold value T2. Similarly, a second type of credit product might be offered at 812 to consumers who met both threshold values T1 and T2 (in addition to, or instead of, the first type of credit product).

Thus, a consumer's responsible use of a pre-paid card account may help him or her migrate to other appropriate credit products.

As used herein and in the appended claims, the term pre-paid “card” account should be understood to refer not only to card-shaped items bearing magnetic stripes but also to other devices, whether or not card shaped, used to input an identification number for accessing a financial account. Thus a pre-paid “card” also includes devices that report account access identification information by proximity coupling, radio frequency identification (RFID) techniques, and the like.

According to some embodiments, a party (such as a credit rating agency) determines information associated with a consumer's historical usage of a pre-paid card account, wherein the consumer: (1) uses the pre-paid card account for purchase transactions, and (2) transfers funds to re-load the pre-paid card account. The party may then determine credit product offer information associated with the consumer based on said historical usage. For example, a credit rating agency may determine a score or category associated with the consumer (and that score or category may be used by another party to select and provide appropriate credit product offers to the consumer).

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method, comprising:
associating a consumer with a pre-paid card account;
facilitating purchase transactions for the consumer via the pre-paid card account, including transferring funds out of the pre-paid card account;
transferring funds for the consumer to re-load the pre-paid card account;
tracking the consumer's usage of the pre-paid card account; and
determining at least one credit product to be offered to the consumer based on said tracking.

2. The method of claim 1, further comprising:
offering the determined credit product to the consumer.

3. The method of claim 2, wherein the credit product offered to the consumer comprises at least of: (i) a traditional credit card account, (ii) a private label credit card account, (iii) a card account with overdraft protection, or (iv) a partially secured credit card account.

4. The method of claim 1, wherein the credit product is linked to the pre-paid card account.

5. The method of claim 1, wherein said determining is further based on credit bureau data.

6. The method of claim 1, wherein the pre-paid card account is co-branded with a retail partner.

7. The method of claim 1, wherein said associating comprises:
issuing a pre-paid card to the consumer.

8. The method of claim 1, wherein at least some of the steps are performed by a financial institution acting as at least one of a bank account or a debit card processor substitute.

9. The method of claim 1, wherein said facilitating is performed to allow point-of-sale purchases by the consumer.

10. The method of claim 1, further comprising:
facilitating access to funds in the pre-paid card account, by the consumer, via an automated teller machine device.

11. The method of claim 1, wherein said transferring funds for the consumer to re-load the pre-paid card account is associated with a direct deposit of payroll funds.

12. The method of claim 1, wherein said transferring funds for the consumer to re-load the pre-paid card account is associated with re-loading the funds, by the consumer, at a merchant location.

13. The method of claim 1, wherein at least some of the purchase transactions facilitated for the consumer are associated with at least one of online purchases or bill paying.

14. A computer-implemented method, comprising:
associating a consumer with a pre-paid card account;
receiving a transaction request, associated with the pre-paid card account, from a remote merchant device;
transmitting a transaction approval to the remote merchant device;
transferring funds out of the pre-paid card account based on the transaction request;
receiving a re-load indication from the consumer;
transferring funds for the consumer to re-load the pre-paid card account in response to the re-load request;
storing transaction information associated with the consumer's usage of the pre-paid card account;
receiving from a third-party supplemental information associated with the consumer;
based on the stored transaction information and the supplemental information, generating a score associated with the consumer;
offering a first credit product to the consumer if the score is in a pre-determined relationship with a first threshold value; and
offering a second credit product to the consumer if the score is in a pre-determined relationship with a second threshold value.

15. An apparatus, comprising:
a processor; and
a storage device in communication with said processor and storing instructions adapted to be executed by said processor to:
associate a consumer with a pre-paid card account;
facilitate purchase transactions for the consumer via the pre-paid card account, including transferring funds out of the pre-paid card account;
transfer funds for the consumer to re-load the pre-paid card account;
track the consumer's usage of the pre-paid card account; and
determine at least one credit product to be offered to the consumer based on said tracking.

16. The apparatus of claim 15, wherein said storage device further stores at least one of: (i) a consumer database, (ii) a pre-paid card account database, or (iii) a credit product database.

17. The apparatus of claim 15, further comprising:
a communication device coupled to said processor and adapted to communicate with at least one of: (i) a point of sale device, (ii) an automated teller machine device, (iii) a consumer device, or (iv) a credit bureau device.

18. A computer-readable medium storing instructions adapted to be executed by a processor to perform a method of offering credit products to consumers, said method comprising:
associating a consumer with a pre-paid card account;
facilitating purchase transactions for the consumer via the pre-paid card account, including transferring funds out of the pre-paid card account;
transferring funds for the consumer to re-load the pre-paid card account;
tracking the consumer's usage of the pre-paid card account; and
selecting a credit product, from a plurality of potential credit products, to be offered to the consumer based on said tracking and supplemental information, from a credit bureau, associated with the consumer.

19. A method, comprising:
determining information associated with a consumer's historical usage of a pre-paid card account, wherein the consumer: (1) uses the pre-paid card account for purchase transactions, and (2) transfers funds to re-load the pre-paid card account; and
determining credit product offer information associated with the consumer based on said historical usage.
